(19) United States
(12) Patent Application Publication
(10) Pub. No.: US 2024/0123374 A1
(43) Pub. Date: Apr. 18, 2024

(54) Oil Filter Cap Assembly

(71) Applicant: Alain Goudreau, Dowling (CA)

(72) Inventor: Alain Goudreau, Dowling (CA)

(21) Appl. No.: 17/965,026

(22) Filed: Oct. 13, 2022

(51) Int. Cl. B01D 27/08

(52) U.S. Cl. CPC B01D 27/08; B01D 2201/306

(57) ABSTRACT

An oil filter cap assembly for inhibiting used motor oil from leaking out of a used oil filter includes an oil filter that has an opening which is threaded thereby facilitating the opening to engage an oil filter port on an internal combustion engine. A cap is removably positioned in the opening of the oil filter and the cap is removed from the opening prior to installing the oil filter on the oil filter port. The cap is threadable into a used oil filter that is removed from the oil filter port thereby inhibiting used motor oil from spilling outwardly from the used oil filter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to oil filter devices and more particularly pertains to a new oil filter device for inhibiting used motor oil from leaking out of a used oil filter. The device includes a cap that comprises a disk and a threaded stem extending away from the disk. The stem threadably engages an opening in a used oil filter such that the disk is compressed against the used oil filter. In this way the cap inhibits used motor oil from leaking out of the used oil filter.

### (2) Description of Related Art Including Information Disclosed Under 37 CFR 1.97 and 1.98

The prior art relates to oil filter devices including a leak proof container to contain a used oil filter that includes a cylinder and a lid hingedly attached to the cylinder. The prior art discloses an oil filter seal that includes a screw that is insertable into an opening in an oil filter, a disk through which the screw passes and a nut that is threadable onto the screw for compressing the disk against the oil filter. The prior art discloses an oil filter cap that includes a pair of grips which each grip a nipple on an oil filter. The prior art discloses an oil filter cap that includes a grip extending around a perimeter of a disk which engages a recess in an outer wall of an oil filter. The prior art discloses an oil filter cap that includes a cap with a threaded stem that threadably engages an opening in an oil filter and a plug that threadably engages a drain in the oil filter. The prior art discloses an ornamental design for an oil filter that includes a drain plug. The prior art discloses an ornamental design for an oil filter extraction tool that includes a disk, a threaded stem extending away from the disk which threadably engages an opening in an oil filter and a ring attached to the disk which is gripped to extract the oil filter.

### BRIEF SUMMARY OF THE INVENTION

An embodiment of the disclosure meets the needs presented above by generally comprising an oil filter that has an opening which is threaded thereby facilitating the opening to engage an oil filter port on an internal combustion engine. A cap is removably positioned in the opening of the oil filter and the cap is removed from the opening prior to installing the oil filter on the oil filter port. The cap is threadable into a used oil filter that is removed from the oil filter port thereby inhibiting used motor oil from spilling outwardly from the used oil filter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom view of a cap of an embodiment of the disclosure.

FIG. 2 is a perspective view of a cap of an embodiment of the disclosure.

FIG. 3 is a front view of a cap of an embodiment of the disclosure.

FIG. 4 is an exploded perspective view of an oil filter cap assembly according to an embodiment of the disclosure.

FIG. 5 is a perspective in-use view of an embodiment of the disclosure showing a cap fully seated in an oil filter.

FIG. 6 is a cross sectional view taken along line 6-6 of FIG. 5 of an embodiment of the disclosure.

### DETAILED DESCRIPTION OF THE INVENTION

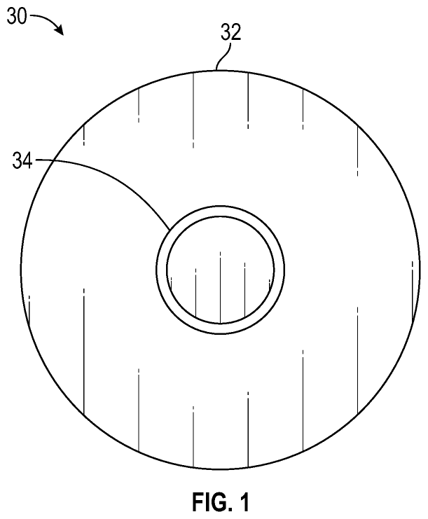

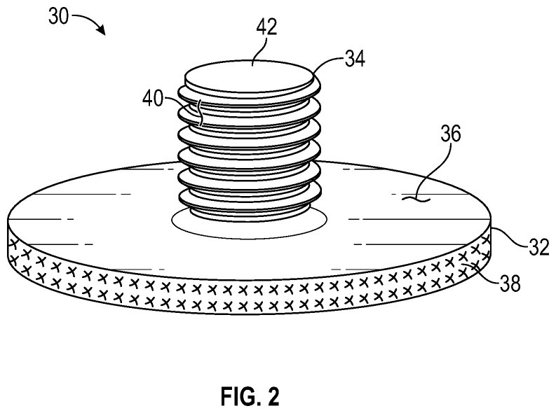

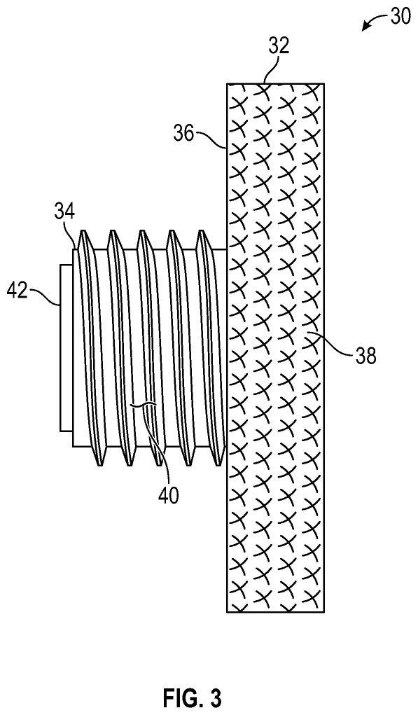

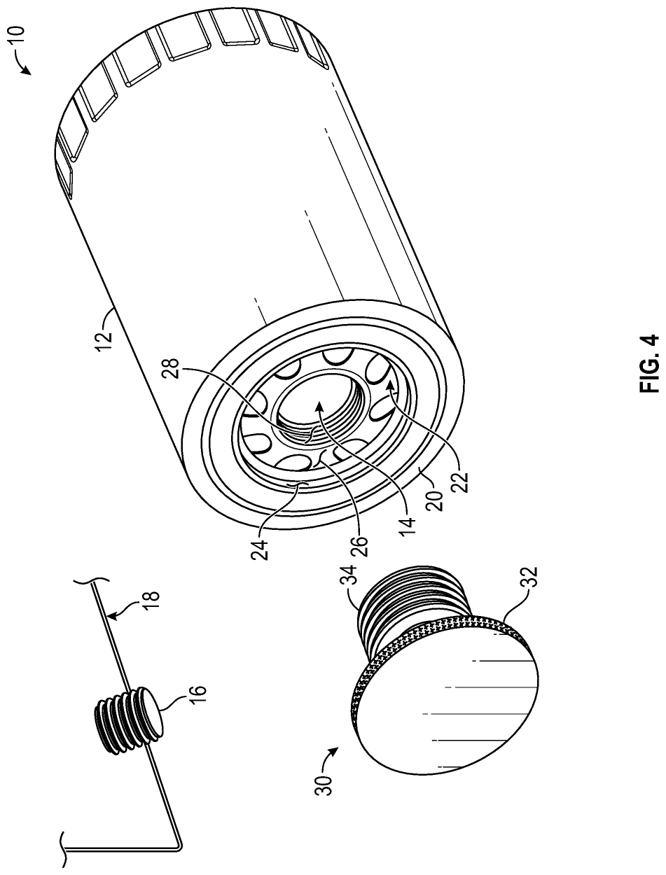

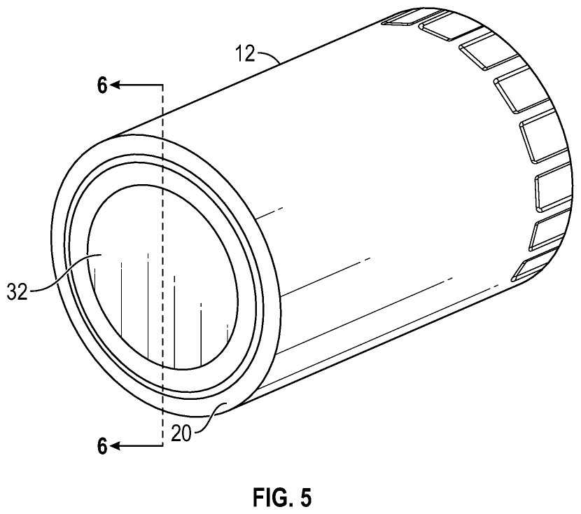

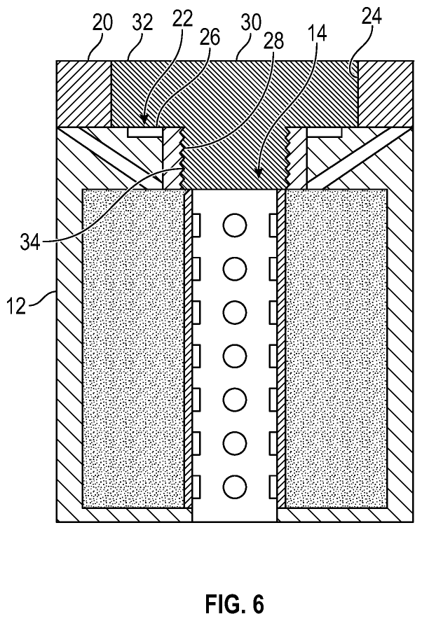

With reference now to the drawings, and in particular to FIGS. 1 through 6 thereof, a new oil filter device embodying the principles and concepts of an embodiment of the disclosure and generally designated by the reference numeral 10 will be described.

As best illustrated in FIGS. 1 through 6, the oil filter cap assembly 10 generally comprises an oil filter 12 that has an opening 14 which is threaded thereby facilitating the opening 14 to engage an oil filter port 16 on an internal combustion engine 18. The internal combustion engine 18 may be an engine in a motorized vehicle, such as a passenger vehicle for example. The oil filter 12 has a top side 20, the opening 14 extends into the top side 20 and the oil filter 12 has a recess 22 extending into the top side 20. The recess 22 has a lateral bounding surface 24 and a lower bounding surface 26 and the opening 14 is centrally positioned on the lower bounding surface 26. Additionally, the opening 14 has a bounding surface 28 and the bounding surface 28 of the opening 14 is threaded.

A cap 30 is provided and the cap 30 is removably positioned in the opening 14 of the oil filter 12. The cap 30 is removed from the opening 14 prior to installing the oil filter 12 on the oil filter port 16. The cap 30 is threadable into a used oil filter 12 that is removed from the oil filter port 16 thereby inhibiting used motor oil from spilling outwardly from the used oil filter 12. In this way the used oil filter 12 can be removed and discarded without spilling used motor oil. The cap 30 may be comprised of plastic or other type of rigid material that has a sufficiently low cost to manufacture.

The cap 30 has a disk 32 and a stem 34 extending away from the disk 32. The disk 32 has a bottom surface 36 and a perimeter edge 38 and the stem 34 is centrally positioned on the bottom surface 36. The stem 34 has an outer surface 40 and a distal end 42 with respect to the bottom surface 36 and the outer surface 40 is threaded. The perimeter edge 38 of the disk 32 is knurled to enhance gripping the disk 32 for tightening or loosening the cap 30 in the oil filter 12. The outer surface 40 of the stem 34 threadably engages the bounding surface 28 of the opening 14. The bottom surface 36 of the disk 32 compresses against the lower bounding surface 26 of the recess 22 in the top side 20 of the oil filter 12 when the stem 34 is fully threaded into the opening 14. The disk 32 has a diameter that is slightly less than the diameter of the recess 22. In this way the perimeter edge 38 of the disk 32 is positioned adjacent to the lateral bounding surface 24 of the recess 22 when the stem 34 is fully threaded into the opening 14.

In use, the oil filter 12 is shipped from the manufacturer with the cap 30 installed in the opening 14. The cap 30 is removed from the opening 14 in the oil filter 12 and the cap 30 is installed in the opening 14 of the used oil filter 12 when the used oil filter 12 is removed from the oil filter port 16 on the internal combustion engine 18. In this way used motor oil is inhibited from leaking out of the used oil filter 12 prior to the used oil filter 12 being discarded. Thus, the used motor oil does not spill onto the floor of a mechanic shop, for example, or other location where the internal combustion engine 18 is being serviced.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An oil filter cap assembly for inhibiting oil from spilling out of a used oil filter, said assembly comprising:
an oil filter having an opening being threaded thereby facilitating said opening to engage an oil filter port on an internal combustion engine; and
a cap being removably positioned in said opening of said oil filter, said cap being removed from said opening prior to installing said oil filter on the oil filter port, said cap being threadable into a used oil filter that is removed from the oil filter port thereby inhibiting used motor oil from spilling outwardly from the used oil filter.

2. The assembly according to claim 1, wherein said oil filter has a top side, said opening extending into said top side, said oil filter having a recess extending into said top side, said recess having a lateral bounding surface and a lower bounding surface, said opening being centrally positioned on said lower bounding surface, said opening having a bounding surface, said bounding surface of said opening being threaded.

3. The assembly according to claim 2, wherein said cap has a disk and a stem extending away from said disk, said disk having a bottom surface and a perimeter edge, said stem being centrally positioned on said bottom surface, said stem having an outer surface and a distal end with respect to said bottom surface, said outer surface being threaded, said perimeter edge of said disk being knurled to enhance gripping said disk for tightening or loosening said cap in said oil filter, said outer surface of said stem threadably engaging said bounding surface of said opening.

4. The assembly according to claim 2, wherein said cap has a disk and a stem, a bottom surface of said disk compresses against said lower bounding surface of said recess in said top side of said oil filter when said stem is fully threaded into said opening.

5. The assembly according to claim 4, wherein said perimeter edge of said disk being positioned adjacent to said lateral bounding surface of said recess when said stem is fully threaded into said opening.

6. An oil filter cap assembly for inhibiting oil from spilling out of a used oil filter, said assembly comprising:
an oil filter having an opening being threaded thereby facilitating said opening to engage an oil filter port on an internal combustion engine, said oil filter having a top side, said opening extending into said top side, said oil filter having a recess extending into said top side, said recess having a lateral bounding surface and a lower bounding surface, said opening being centrally positioned on said lower bounding surface, said opening having a bounding surface, said bounding surface of said opening being threaded, and
a cap being removably positioned in said opening of said oil filter, said cap being removed from said opening prior to installing said oil filter on the oil filter port, said cap being threadable into a used oil filter that is removed from the oil filter port thereby inhibiting used motor oil from spilling outwardly from said used oil filter, said cap having a disk and a stem extending away from said disk, said disk having a bottom surface and a perimeter edge, said stem being centrally positioned on said bottom surface, said stem having an outer surface and a distal end with respect to said bottom surface, said outer surface being threaded, said perimeter edge of said disk being knurled to enhance gripping said disk for tightening or loosening said cap in said oil filter, said outer surface of said stem threadably engaging said bounding surface of said opening, said bottom surface of said disk compressing against said lower bounding surface of said recess in said top side of said oil filter when said stem is fully threaded into said opening, said perimeter edge of said disk being positioned adjacent to said lateral bounding surface of said recess when said stem is fully threaded into said opening.

7. A method of inhibiting motor oil from leaking out of a used oil filter, the steps of the method comprising:
providing an oil filter having an opening, said opening having a bounding surface being threaded;
providing cap having a disk and a threaded stem;
inserting said threaded stem into said opening;
rotating said cap such that said threaded stem threadably engages said bounding surface of said opening; and
tightening said cap until said disk compresses against said oil filter thereby inhibiting used motor oil from leaking outwardly from said opening.
